(19) United States
(12) Patent Application Publication
(10) Pub. No.: US 2009/0102722 A1
(43) Pub. Date: Apr. 23, 2009

(54) INVERTED F-TYPE ANTENNA

(76) Inventor: Yao-Wen YU, Pa-Te City (TW)

Correspondence Address: SINORICA, LLC, 528 FALLSGROVE DRIVE, ROCKVILLE, MD, 20850, US

(21) Appl. No.: 11/877,251

(22) Filed: Oct. 23, 2007

(51) Int. Cl. H01Q 9/04

(52) U.S. Cl. 343/700 MS

(57) ABSTRACT

An inverted F-type antenna, the antenna mainly comprises a low-frequency radiation arm, a high-frequency radiation arm and a main signal line; an end of the high-frequency radiation arm is connected to a grounding line, and the main signal line is extended upwards from the high-frequency radiation arm, a single signal feed-in point is provided at a connecting area of the main signal line with the high-frequency radiation arm. By forming a loop between the grounding line and the feed-in point, the antenna can provide a high frequency effect.

### BACKGROUND OF THE INVENTION

1. Field of the Invention

The present invention relates to an inverted F-type antenna, and especially to an inverted F-type antenna which can be wound to reduce its volume and suits a notebook.

2. Description of the Prior Art

In fast progression of the technique of wireless communication and portable electronic equipment (such as notebooks), practical using of antennas needs that they shall be compacted and have a function of multiple frequencies; it is always a direction sought by the art to increase the efficiencies of antennas and make the same suitable to be mounted in notebooks.

A conventionally used multi-frequency antenna structure has a grounding surface and a first metallic radiation arm; a first parasitic short circuit metallic arm and a second parasitic short circuit metallic arm are respectively used to make coupling resonance with the first metallic radiation arm for forming two action frequency ranges, thus an effect of multiple frequencies can be provided.

When such a conventionally structure is wound to form an elongate I-bar, a holder must be used to fix it; thereby it is difficult to be assembled, and improvement is wanted.

### SUMMARY OF THE INVENTION

The present invention mainly is to provide an inverted F-type antenna, the antenna mainly comprises a low-frequency radiation arm, a high-frequency radiation arm and a main signal line; an end of the high-frequency radiation arm is connected to a grounding line, and the main signal line is extended upwards from the high-frequency radiation arm, a single signal feed-in point is provided at a connecting area of the main signal line with the high-frequency radiation arm. By forming a loop between the grounding line and the feed-in point, the antenna can provide a high frequency effect.

The inverted F-type antenna provided by the present invention can be directly wound to form a hollow I-bar, or can be attached to a soft plate for winding, in order to reduce the volume of the entire antenna, it is suitable to be mounted in any of various notebooks.

The present invention will be apparent in its structural feature and effect in use after reading the detailed description of the preferred embodiment thereof in reference to the accompanying drawings.

### BRIEF DESCRIPTION OF THE DRAWINGS

FIG. 1 is a plan view of the present invention; in which dotted lines represent folding lines;

FIG. 2 is a plan view of the present invention, showing that a grounding end is connected via a grounding line to a feed-in point to form a loop;

FIG. 3 is perspective view showing that the present invention is wound to form a hollow I-bar;

FIG. 4 is a perspective view showing that the present invention is assembled on an insulating elongate rod;

FIG. 5 is a perspective view of FIG. 4 viewed from another angular position.

### DETAILED DESCRIPTION OF THE PREFERRED EMBODIMENT

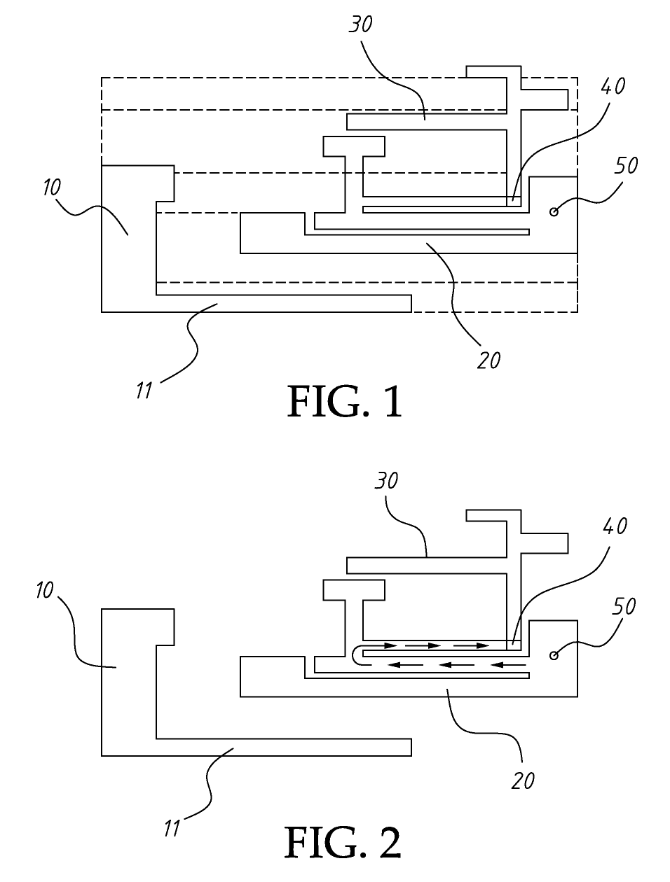

Referring to FIGS. 1 and 2, an inverted F-type antenna provided by the present invention mainly comprises a low-frequency radiation arm 10, a high-frequency radiation arm 20 and a main signal line 30.

The low-frequency radiation arm 10 is in the shape of “L”, thus it has a low-frequency parasitic arm 11 extending therefrom. The main signal line 30 is diverged and extended upwards from the high-frequency radiation arm 20, a single signal feed-in point 40 is provided at a connecting area of the main signal line 30 with the high-frequency radiation arm 20; the single signal feed-in point 40 can be connected to a signal connecting line.

Referring to FIG. 2, the main technique of the present invention uses a grounding line to connect a grounding end 50 to the single signal feed-in point 40 to form a loop, as is shown by arrows in the drawing, thereby the antenna can provide a high frequency effect and can be used in a high frequency range.

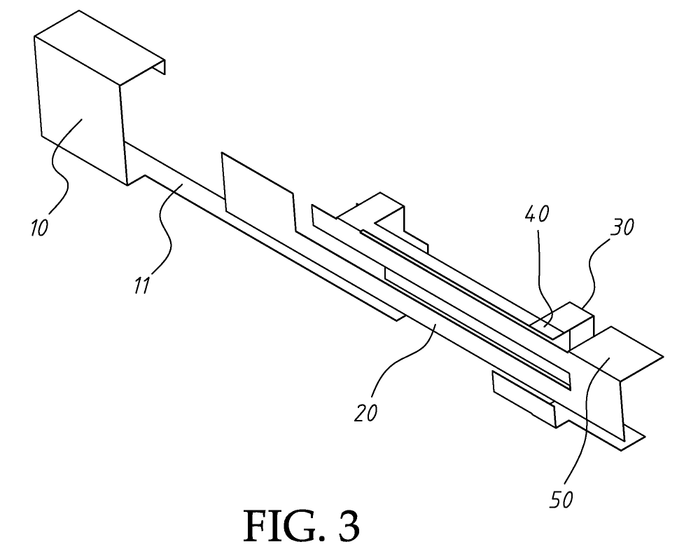

The low-frequency radiation arm 10, the high-frequency radiation arm 20 and the main signal line 30 are made of flexible metals, and can be folded about dotted lines depicted in FIG. 1 to be wound and form a hollow I-bar as is shown in FIG. 3, thus the antenna can be used and assembled in any of various notebooks.

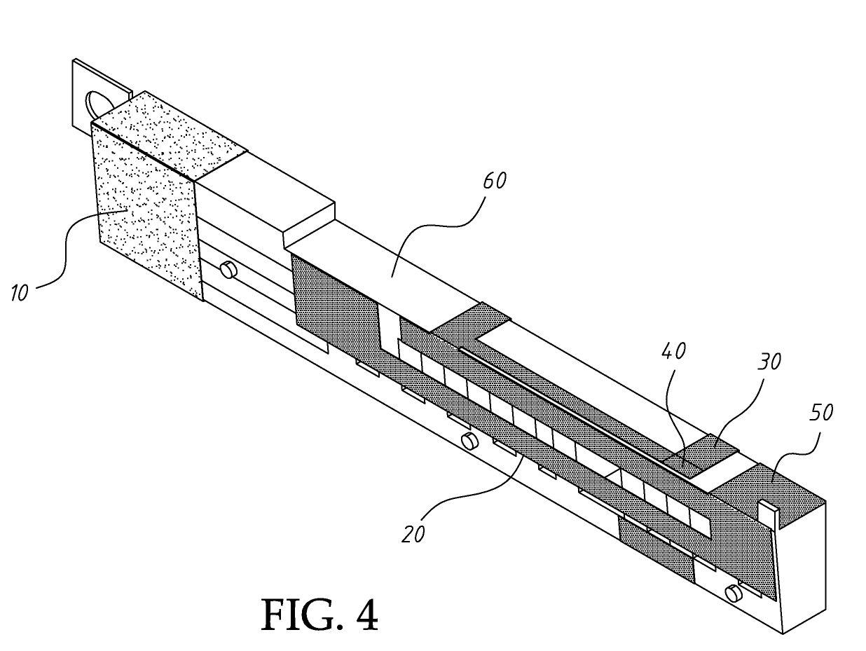

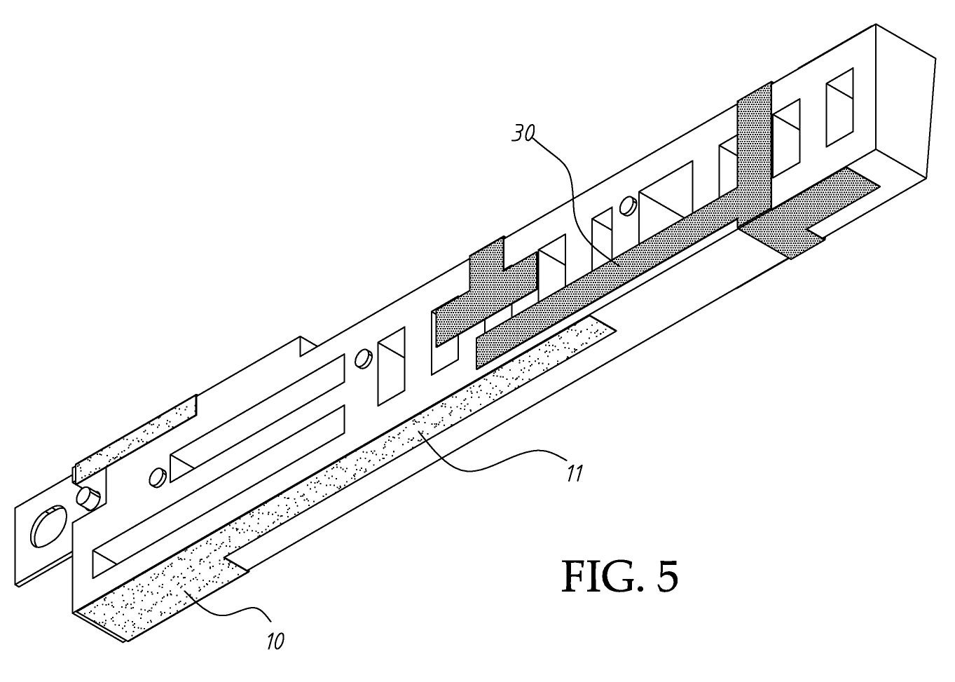

The low-frequency radiation arm 10, the high-frequency radiation arm 20 and the main signal line 30 can be carried on a soft plate, and can be folded and wound in order to reduce the volume of the entire antenna; or can be folded, as shown in FIG. 4, to form a hollow I-bar to be assembled on external surfaces of an insulating elongate rod 60.

Referring to FIG. 5 which is a perspective view of FIG. 4 viewed from another angular position, after the low-frequency radiation arm 10 is folded, the low-frequency parasitic arm 11 gets close to be coupled to and resonates with the main signal line 30 to generate a low frequency effect, thus the antenna can be used in a high frequency range.

Therefore, the present invention uses the low-frequency radiation arm 10, the high-frequency radiation arm 20, the grounding end 50 which is connected to the single signal feed-in point 40 to form a loop, and the low-frequency parasitic arm 11 to get close to be coupled to and resonate with the main signal line 30, thus to generate multiple action frequency ranges, and to make the antenna have the function of multiple frequencies.

Having now particularly described and ascertained the novelty and improvement of my invention and in what manner the same is to be performed, what we claim will be declared in the claims followed.

1. An inverted F-type antenna comprising:
a low-frequency radiation arm;
a high-frequency radiation arm of which a grounding end is connected to a grounding line;
a main signal line extended upwards from said high-frequency radiation arm; and
a single signal feed-in point provided at a connecting area of said main signal line with said high-frequency radiation arm, said single signal feed-in point is connected to a signal connecting line;
a loop is formed between said grounding line and said single signal feed-in point to form a loop, thus said antenna provides a high frequency effect.

2. The inverted F-type antenna as defined in claim 1, wherein said low-frequency radiation arm, said high-frequency radiation arm and said main signal line are made of flexible metals to be folded and wound to form a hollow I-bar.

3. The inverted F-type antenna as defined in claim 2, wherein said low-frequency radiation arm has a low-frequency parasitic arm extending therefrom; after said low-frequency radiation arm is folded, it gets close to be coupled to and resonates with said main signal line to generate a low frequency effect.

4. The inverted F-type antenna as defined in claim 2, wherein said hollow I-bar being folded is assembled on external surfaces of an insulating elongate rod.

5. The inverted F-type antenna as defined in claim 2, wherein said antenna further comprises a soft plate; said low-frequency radiation arm, said high-frequency radiation arm and said main signal line are carried on said soft plate, and are folded and wound in order to reduce volume of said antenna.
